(19) United States
(12) Patent Application Publication
(10) Pub. No.: US 2026/0320017 A1
(43) Pub. Date: Oct. 15, 2026

(54) DISTRIBUTED LEDGER SYSTEM AND METHOD

(71) Applicant: NFTS & FREQUENCIES PTY LTD, Loganlea, Queensland (AU)

(72) Inventor: Wilson Lachlan, Loganlea (AU)

(21) Appl. No.: 19/484,859

(22) PCT Filed: May 15, 2024
(86) PCT No.: PCT/AU2024/050486

§ 371 Date: Nov. 15, 2025

(30) Foreign Application Priority Data
May 15, 2023 (AU) 2023901483

(51) Int. Cl. G06F 16/22

(52) U.S. Cl. CPC G06F 16/2255

(57) ABSTRACT

A distributed ledger method and system is provided, that enables musicians to easily generate NFTs that are engaging and relevant. The method includes: receiving, on a data interface, a digital audio file; generating, on a processor, an image according to the digital audio file; and minting a non-fungible token (NFT) on a distributed ledger, the NFT including the digital audio file and the image.

### CLAIM OF PRIORITY

This application claims priority to, and incorporates by reference herein the entirety of the disclosure of PCT Application No. PCT/AU2024/050486 titled “DISTRIBUTED LEDGER SYSTEM AND METHOD” filed on May 15, 2024.

### FIELD OF TECHNOLOGY

The present invention relates to distributed ledgers, such as a blockchain. In particular, the present invention relates non-fungible tokens on distributed ledgers, such as a blockchain.

### BACKGROUND

A blockchain is a distributed ledger comprising a list of records (blocks) that are securely linked together via cryptographic hashes. Each block contains a cryptographic hash of the previous block, a timestamp, and transaction data. Since each block contains information about the previous block, they effectively form a ‘chain’ of blocks such that the data in any given block cannot be altered retroactively.

A non-fungible token (NFT) is a unique digital identifier (e.g. a token) that is recorded on a blockchain, and typically contains references to a digital file, such as an image. The ownership of an NFT is recorded in the blockchain and can be transferred by the owner, allowing NFTs to be sold and traded.

Digital art is currently one of the most common use cases for NFTs. Most commonly, an image comprising the artwork is associated with the NFT, and artists are able to generate revenue by selling NFTs with their artwork.

While image-based NFTs are most common, any type of digital data may be associated with an NFT, including sound. As an illustrative example, a music NFT is typically simply an NFT that is linked to music.

A problem with music NFTs from the perspective of fans and collectors is that they are not visually appealing and cannot be as easily showcased as image-based NFTs. As a result, musicians often create NFTs including image-based artwork for collectors and fans.

A problem with such image NFTS in the music industry is that they require the creation of artwork, which is generally unrelated to the artist's music, and often created by a third party. This is generally costly and time-consuming and does not showcase the talent of the musician.

As such, there is clearly a need for improved distributed ledger methods and systems, particularly, but not exclusively, for musicians.

It will be clearly understood that, if a prior art publication is referred to herein, this reference does not constitute an admission that the publication forms part of the common general knowledge in the art in Australia or in any other country.

### SUMMARY

The present invention relates to distributed ledger systems and methods, which may at least partially overcome at least one of the abovementioned disadvantages or provide the consumer with a useful or commercial choice.

With the foregoing in view, the present invention in one form, resides broadly in a distributed ledger system including:
a distributed ledger, comprising a plurality of non-fungible tokens;
one or more servers interfacing with the distributed ledger, the one or more servers including a data interface and a processor, configured to:
receive, on the data interface, a digital audio file;
generate, on the processor, an image according to the digital audio file; and
mint a non-fungible token (NFT) on the distributed ledger, the NFT including the image, and optionally the digital audio file.

In another form, the invention resides broadly in a distributed ledger method including:
receiving, on a data interface, a digital audio file;
generating, on a processor, an image according to the digital audio file; and
minting a non-fungible token (NFT) on a distributed ledger, the NFT including the image, and optionally the digital audio file.

Advantageously, the distributed ledger system and method enables musicians (and others) to generate revenue from the sale of the NFT in a manner that showcases their music (or other audio), both through the audio file and the image generated therefrom. This is more visually appealing than an audio file alone, and the imagery relates to the audio file (as it is generated therefrom), rather than being arbitrarily linked to the audio file.

Preferably, the distributed ledger comprises at least one blockchain. The blockchain generally comprises a plurality of blocks, wherein the NFTs, and transactions relating thereto are stored as blocks on the blockchain.

The blockchain may use, for example, proof of stake, proof of work, and/or another consensus mechanism and may contain one or more protocols to determine consistency in the blockchain, including ownership of the NFT, or to alter and/or destroy the NFT (e.g. following the consumption of an associated benefit, as outlined below).

The blockchain may comprise an Ethereum blockchain.

Preferably, the NFT comprises an ERC-721 token on an Ethereum blockchain.

The NFT may include the digital audio file and the image through a Uniform Resource Identifier (URI) encoded in the NFT. As such, the NFT may indirectly include the digital audio file and image through the URI.

Preferably, the NFT includes metadata that describes the audio file and/or the image.

The metadata may include a hash of the image and sound clip, to enable persons to verify that any off-chain data has not been modified.

Preferably, the NFT is minted according to one or more smart contracts.

The one or more smart contracts may define one or more rules around the transfer of the NFT. The rules may include rules regarding how payments are made to one or more entities, such as a musician associated with the audio clip and/or a third party, upon transfer of the NFT. In other words, the smart contract may define automated payments to one or more users every time the NFT is transferred/sold.

In some embodiments, a payment is made to a musician and a third party for each transaction relating to the NFT.

The payments may comprise automated payments according to the smart contract.

In some embodiments, the payments can be automatically provided in the form of a cryptographic token.

The use of payments in the form of transaction fees enables a musician (or other person) to generate revenue, even after the NFT is initially sold, when the NFT is sold in a secondary market.

The NFT may be associated with one or more off-chain benefits. The off-chain benefits may relate to online and/or offline benefits.

The online benefits may relate to access to online content, such as music or access to virtual events.

The offline benefits may relate to concert tickets, merchandise, or physical goods.

In some embodiments, redemption of a benefit is stored in the distributed ledger. This enables benefits to be redeemed a limited number of times (e.g. a single time in case of a concert ticket), as defined in a smart contract.

Preferably, the digital audio file comprises a sound clip. The digital audio file may be provided in any suitable format, including MP3 (i.e. MPEG-1 Audio Layer III or MPEG-2 Audio Layer III).

The method or system may enable a user to generate the digital audio file from a larger input file or library of digital audio. The digital audio file may comprise music. The digital audio file may comprise a song or a portion of a song. The digital audio file may comprise voice.

A user interface may be provided enabling the user to select sound clips from audio files or libraries of audio files. The user interface may enable the selection of sound clips of predefined length (e.g. 5 s) from longer audio files.

In other embodiments, a microphone may be provided, on which the user may record a message.

The digital audio file may be analysed to generate the image. The image may comprise a graphical representation of the sound clip.

The image may be generated at least in part according to a soundwave of the digital audio file, or part thereof.

A soundwave of the digital audio file may be generated at least in part according to one or more user-specified parameters. The parameters may include a sampling resolution.

The soundwave may be overlaid onto a background image. The soundwave may be overlaid onto a pre-defined portion of the background image. The soundwave may be overlaid onto the background image according to a template. The template may define a colour and/or location of the soundwave with reference to the background image.

The image may be generated at least in part according to spectral analysis of the digital audio file.

The image may be generated at least in part according to one or more user-defined parameters.

The user-defined parameters may include colours, graphics, text or other visual elements added to the image.

The image may be defined according to any suitable format, including JPEG (Joint Photographic Experts Group).

The image may comprise an image of a sequence of images. The image may comprise a plurality of images. The image may comprise an image of a video, the video comprising a plurality of images. The plurality of images may be generated.

The data store may comprise an off-chain data store.

The method or system may include storing the digital audio file and the image in a data store, separate to the distributed ledger, such that the NFT links to the digital audio file and the image in a data store.

The data store may comprise a cloud server. The data store may comprise a distributed data store. The distributed data store may comprise the InterPlanetary File System (IPFS).

The system and method may enable automatic or semi-automatic generation of NFTs. In such case a batch of NFTs may be created in a similar manner to a single NFT.

The batch of NFTS may be created in an identical manner, but based on different audio files.

In some embodiments, a larger audio file or group of audio files is provided, which is segmented to provide multiple audio files (each of which from an NFT is created). Such segmentation may be automatic.

The method and system may include providing a digital marketplace, enabling the purchase and sale of the NFTs.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF THE DRAWINGS

Various embodiments of the invention will be described with reference to the following drawings, in which:

FIG. 1 illustrates a blockchain system, according to an embodiment of the present invention.

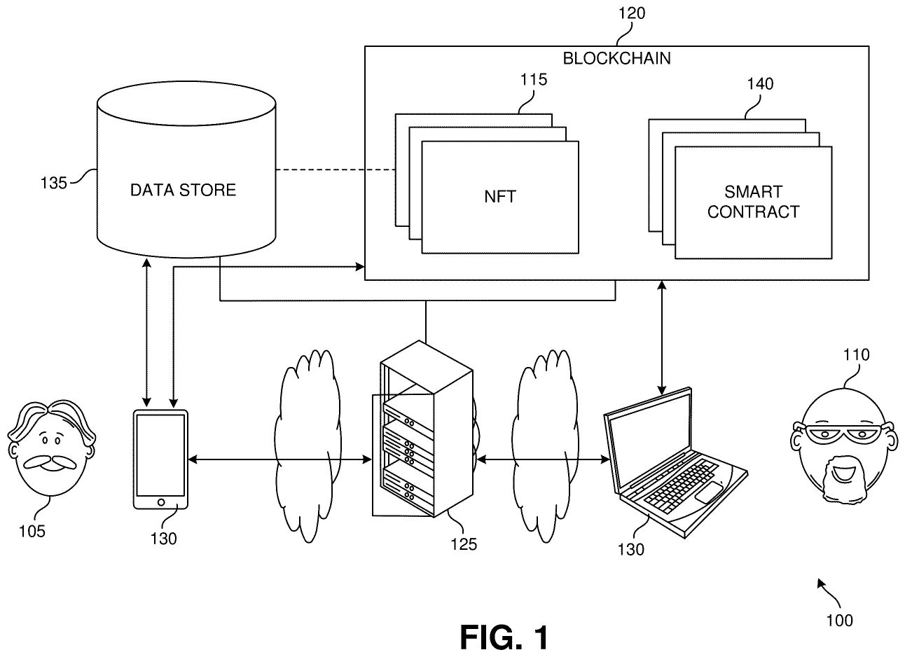

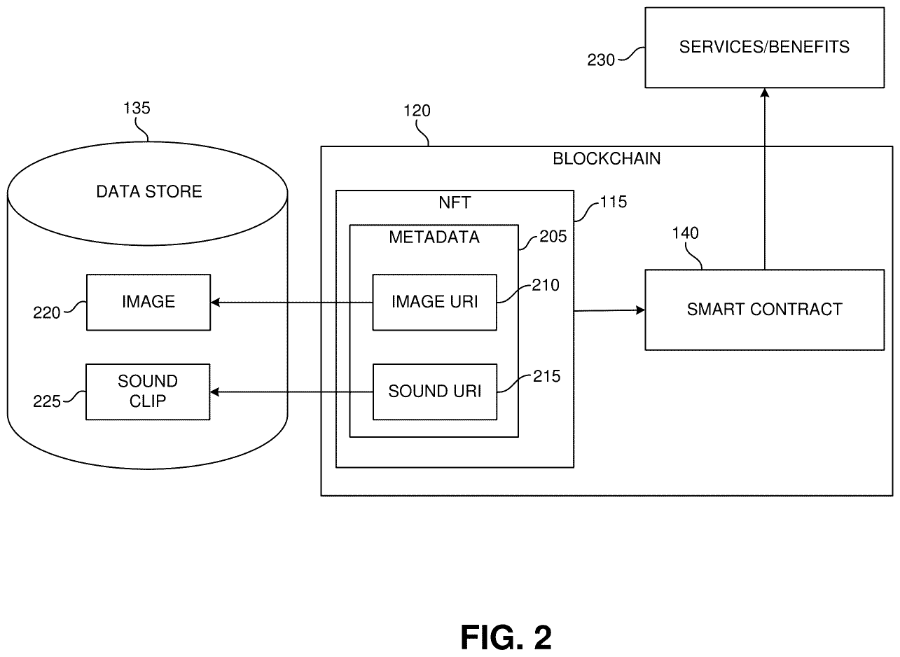

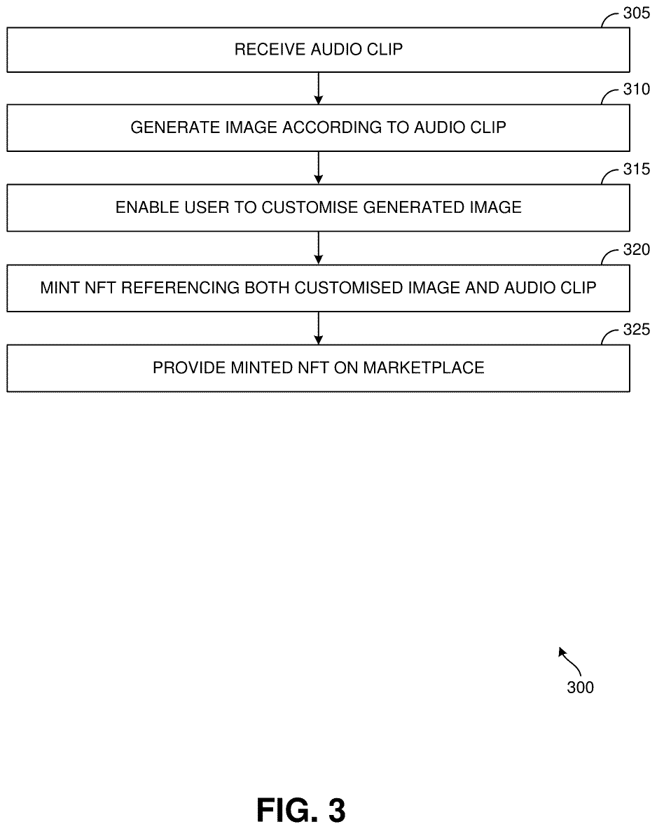

### FIG. 2 illustrates a portion of the blockchain system of FIG. 1, illustrating a single NFT.

FIG. 3 illustrates a blockchain method, according to an embodiment of the present invention.

Preferred features, embodiments and variations of the invention may be discerned From the following Detailed Description which provides sufficient information for those skilled in the art to perform the invention. The Detailed Description is not to be regarded as limiting the scope of the preceding Summary of the Invention in any way.

### DETAILED DESCRIPTION

Embodiments of distributed ledger systems and methods are described below that simplify creation of non-fungible tokens (NFTs), which are particularly useful in the music industry.

FIG. 1 illustrates a blockchain system 100, according to an embodiment of the present invention. The blockchain system 100 enables fans 105 to directly support musicians 110 using non-fungible tokens (NFTs) 115 on a blockchain 120. The NFTs 115 may also be associated with benefits for the fans 105, which may increase engagement between the fans 105 and the musicians 110, as outlined in further detail below.

The system 100 includes one or more servers 125, with which the fans 105 and musicians 110 interact, using respective computing devices 130. The servers 125 function as web servers, among other things, and provide a user interface to the blockchain 120, on which the NFTs 115 are provided.

The blockchain 120 generally comprises a plurality of blocks, wherein the NFTs 115, and transactions relating thereto are stored as blocks on the blockchain 120. The blockchain 120 may, for example, comprise an Ethereum blockchain. Furthermore, while the term “blockchain” is used in singular, the skilled addressee will readily appreciate that any number of blockchains may be used together as a distributed ledger.

To create an NFT, the musician 110 initially uploads (or otherwise provides), a sound clip to the server 125. This may be performed by selecting a portion of a song from a library of songs, for example.

The server 125 then analyses the sound clip to generate a graphical representation of the sound clip, or part thereof, in the form of one or more sound waves.

The sound wave is then provided to the musician as an image on a user interface, enabling the user to customise the sound wave. This may include technical customisation of the sound wave itself (e.g. by selecting a resolution or other parameters of how the sound wave is generated), cropping (e.g. selecting a subset of the sound wave), or any other suitable modification of the sound wave.

The image may also be customised, e.g. by selecting a colour or background on which the sound wave is overlaid. As an illustrative example, the sound wave may be overlaid over an image selected by the musician. Similarly, colours, graphics, text or other visual elements may be added to the image.

In some embodiments, a ‘cartoon’ version of the musician may be generated or provided, where the sound wave is overlaid on a feature of the cartoon (e.g. on a bottle held by the cartoon image of the musician), rather than as the background.

The image may further include a variety of other image components, such as a signature or image of the musician, which components may be combined according to a template or other suitable manner.

Once the image comprising the sound wave is finalised, it is stored on a data store 135, together with the sound clip, in a manner that is accessible, e.g. by the Internet.

An NFT 115 is then minted on the blockchain 120 using a smart contract 140, and linking to the image comprising the sound wave and the sound clip. The NFT 115 comprises a unique token (e.g. an ERC-721 token) on the blockchain 120 that links to, and optionally represents ownership of, the digital assets (i.e. the image comprising the sound wave and the sound clip).

FIG. 2 illustrates a portion of the blockchain system 100, illustrating a single NFT.

The NFT 115 includes metadata 205 that describes the digital asset, such as its name, description, together with links to the digital assets in the form of an image Uniform Resource Identifier (URI) 210, and a sound URI 215.

The image URI 210 and the sound URI 215 link to an image location 220 and

### A Sound Clip Location 225 on the Data Store 135, the Image Location 220 Defining a Location

of the image associated with the NFT 115, and the sound clip location 225 defining a location of the sound clip associated with the NFT 115.

The data store 135 may comprise any suitable data store, such as a cloud server, or a distributed data store, such as the InterPlanetary File System (IPFS), and is generally an off-chain data store.

The metadata 205 may include a hash of the image and a hash of the sound clip, to enable persons to verify that any off-chain data has not been modified.

The metadata 205, being part of the NFT 115 and thus stored on the blockchain 120, can be accessed by anyone who interacts with the NFT 115, whereas the digital assets (i.e. the image comprising the sound wave and the sound clip) reside externally to the blockchain 120 (i.e. off-chain).

Such configuration ensures that the NFT 115 itself remains relatively small, saving on gas fees when transactions are performed. In other embodiments, however, one or more of the image and sound clip may be stored on the blockchain.

The smart contract 140 defines the rules around the NFT 115, including how payments are made to the musician 110. As an illustrative example, the smart contract 140 may define automated payments to the musician 110 every time the NFT 115 is transferred/sold. Similarly, the smart contract may define automated payments to a third party, e.g. an entity that manages the system 100, every time the NFT 115 is transferred/sold, as a source of management fees.

Once the NFT 115 has been minted, it is associated with the blockchain address of the musician 110, and may be listed for sale on a marketplace or other platform that supports NFT transactions. This marketplace may be provided by the one or more servers 125.

As outlined above, fans 105 may interact with the one or more servers 125 using respective computing devices 130 to purchase NFTs 115, which enables fans 105 to purchase NFTs 115 from the musicians 110. When a fan 105 purchases the NFT 115, ownership is transferred to their blockchain address. This is recorded on the blockchain 120 and can be verified by anyone, and the fan 105 may use the NFT outside of the environment of the server 125.

This initial transaction will generally result in revenue for the musician 110, as the musician has sold the NFT 115, but as outlined above, a smart contract 140 associated with the NFT 115 may also provide revenue to the musician 110 for subsequent transfers.

In addition to providing terms relating to payments when an NFT is transferred, the smart contract 140 may also define one or more other services or benefits 230.

As an illustrative example, the smart contract may enable early or exclusive access to online content, either via membership websites or apps, priority access and or discounts to ticket sales, merchandise etc.

In such case, the smart contract 140 may define terms relating to such services or benefits 230. In some embodiments, the smart contract may define how many times an action can be performed, update the distributed ledger accordingly. As an illustrative example, the smart contract may define that discounts may be applied only a certain number of times, and update the ledger each time the discount is used. In other examples, a concert ticket or similar benefit may be associated with the NFT 115, which may only be used once.

The system 100 described above provides a quick and easy way for musicians to generate NFTs 115, which may be used as a source of revenue. The NFTs are customised to the musician, through both the sound wave image and the sound clip, and thus provides a unique, but meaningful, visual representation associated with the sound clip.

FIG. 3 illustrates a blockchain method 300, according to an embodiment of the present invention. The blockchain method 300 may be similar or identical to the method performed by the system 100.

At step 305, an audio clip is received. The audio clip may be generated from a library of audio, and may, for example, comprise a portion of a song. In other embodiments, the audio clip may be generated directly, e.g. from a microphone. Such configuration is particularly useful when the musician 110 is recording a message.

At step 310, the audio clip is analysed, and an image is generated according to the analysed audio clip. The analysis may include generating a sound wave or performing spectral analysis of the audio clip, for example.

At step 315, an interface is provided enabling the user to customise the generated image. This can include changing the sampling rate (resolution) of the sound wave, colours or other characteristics of the sound wave, choosing a background on which the sound wave is provided, or otherwise modifying the image.

At step 320, an NFT is minted, including (referencing) both the (customised) image and the audio clip. This may include uploading the customised image and the audio clip to a data store, and including a URI in the NFT linking to the customised image and audio clip in the data store.

The NFT is minted using a smart contract, which may define terms associated with the NFT, including payments to the musician (creator) and/or third parties.

At step 325, the NFT is provided on a marketplace for sale. The marketplace be online, and may be in the form of an auction, fixed price, or any other suitable marketplace, or combination thereof. The marketplace may be provided by the server 125 in the form of a web page.

The above example describes the use of sound clips to generate the NFT. The sound clips may comprise entire songs, parts of songs, or a voice recording from the musician.

In some embodiments, the system enables the musician to easily select different parts of songs, to potentially enable a large number of NFTs to be created, each with a unique portion of a song.

In some embodiments, the sound waves may be processed to generate imagery in a manner selected by the musician. As an illustrative example, one or more visual effects may be provided to the sound wave, including smoothing, filtering, or other effects.

In some embodiments, the system 100 enables a batch of NFTs 115 to be generated based upon defined parameters. As an illustrative example, a batch of NFTs 115 may be created based upon different songs (or portions of songs) from a library of songs, e.g. by having the system automatically select different parts of songs. This may be performed by segmentation of songs, e.g. into 5-second intervals.

These NFTs 115 may be created in a similar manner (e.g. using the same resolution, colour, background, etc), but using different songs or portions thereof to generate the sound wave.

Such configuration enables the musician to create a large number of NFTs, each of which is unique, in an easy manner (e.g. through a single action).

While the above embodiments describe the use of sound waves, the skilled addressee will readily appreciate that in other embodiments, instead of sound waves, other graphical representations of the sound clip may be used, including spectral analysis. In such case, the musician 110 may select the frequency range and resolution that creates imagery that suits their desired style.

Similarly, the sound wave may be represented in any suitable manner. As an illustrative example, instead of a continuous sound wave, a sequence of discrete bars or elements may represent the sound wave.

While the above description refers to generation of an image (singular), the skilled addressee will readily appreciate that multiple images may be generated. The multiple images may comprise images of a video.

Advantageously, the methods and systems described above enable musicians to generate NFTs that relate to their music, in a simple manner. This in turn enables fans to directly support musicians by purchasing these NFTs, and including both a visual and audible element (image and sound clip). This is generally more engaging than NFTs without imagery, or with arbitrary imagery.

The NFTs may also be associated with benefits for the fans, which may further increase engagement between the fans and the musicians.

In some embodiments, the musicians are able to generate large numbers of NFTs simultaneously, e.g. based upon different clips from songs. This in turn further simplifies the process of monetising their creative works.

While the above describes musicians and fans, the skilled addressee will readily appreciate that the teachings hereof may be applied to any suitable persons. As an illustrative example, the NFT may relate to any type of sound, including music and/or speech. For example, an NFT may relate to a recording of a political speech, or a portion thereof.

Similarly, while describing blockchain (and in particular, Ethereum), the skilled addressee will readily appreciate that any suitable distributed ledger system may be used.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A distributed ledger system including:
a distributed ledger, comprising a plurality of non-fungible tokens;
one or more servers interfacing with the distributed ledger, the one or more servers including a data interface and a processor, configured to:
receive, on the data interface, a digital audio file;
generate, on the processor, an image according to the digital audio file; and
mint a non-fungible token (NFT) on the distributed ledger, the NFT including the image.

2. The distributed ledger system of claim 1, wherein the NFT further includes the audio file or a link to the audio file.

3. The distributed ledger system of claim 1, wherein the distributed ledger comprises at least one blockchain, wherein the at least one blockchain comprises a plurality of blocks, and wherein the NFTs and transactions relating thereto are stored as blocks on the at least one blockchain.

4. The distributed ledger system of claim 1, wherein the at least one blockchain comprises an Ethereum blockchain, and wherein the NFT comprises an ERC-721 token on the Ethereum blockchain.

5. The distributed ledger system of claim 1, wherein the NFT includes the digital audio file and the image through a Uniform Resource Identifier (URI) encoded in the NFT.

6. The distributed ledger system of claim 1, wherein the NFT includes metadata that describes the audio file and/or the image.

7. The distributed ledger system of claim 6, wherein the metadata includes a hash of the image and the audio file, to enable persons to verify that any off-chain data has not been modified.

8. The distributed ledger system of claim 1, wherein the NFT is minted according to one or more smart contracts, wherein the one or more smart contracts define one or more rules around the transfer of the NFT, the one or more rules including automated payment rules, defining automated payments to one or more users when the NFT is transferred or sold, wherein the automated payments are defined in the one or more smart contracts, and wherein the payments comprise cryptographic tokens.

9. The distributed ledger system of claim 8, wherein the automated payments include a payment made to a musician associated with the digital audio file.

10. The distributed ledger system of claim 1, wherein the NFT is associated with one or more off-chain benefits, wherein redemption of a benefit of the one or more off-chain benefits is stored in the distributed ledger.

11. The distributed ledger system of claim 1, wherein the digital audio file comprises music.

12. The distributed ledger system of claim 1, configured to generate the digital audio file from a larger input file or library of digital audio.

13. The distributed ledger system of claim 12, wherein the digital audio file comprises a portion of a song.

14. The distributed ledger system of claim 1, wherein the one or more servers are configured to provide a user interface, enabling a user to generate the digital audio file from audio files or libraries of audio files.

15. The distributed ledger system of claim 1, wherein the digital audio file is analysed to generate the image.

16. The distributed ledger system of claim 1, wherein the image comprises a graphical representation of the digital audio file.

17. The distributed ledger system of claim 1, wherein the image is generated at least in part according to a soundwave of the digital audio file, or part thereof, wherein the soundwave of the digital audio file is generated at least in part according to one or more user-specified parameters, and wherein the soundwave is overlaid onto a background image.

18. The distributed ledger system of claim 1, wherein the one or more servers comprise an off-chain data store, for storing the digital audio file and the image, such that the NFT links to the digital audio file and the image in the data store.

19. The distributed ledger system of claim 1, wherein a plurality of images are generated, and NFTs are minted, according to different segments of an audio file or audio files.

20. A distributed ledger method including:
receiving, on a data interface, a digital audio file;
generating, on a processor, an image according to the digital audio file; and
minting a non-fungible token (NFT) on a distributed ledger, the NFT including the image and optionally the digital audio file.
